(19) United States
(12) Patent Application Publication
(10) Pub. No.: US 2013/0234510 A1
(43) Pub. Date: Sep. 12, 2013

(54) ELECTRIC VEHICLE INVERTER DEVICE

(71) Applicant: Yasushi NAKAMURA, Nishio (JP)

(72) Inventor: Yasushi NAKAMURA, Nishio (JP)

(21) Appl. No.: 13/756,955

(22) Filed: Feb. 1, 2013

(30) Foreign Application Priority Data
Mar. 9, 2012 (JP) 2012-053823

(51) Int. Cl. B60L 11/00

(52) U.S. Cl. CPC B60L 11/00
USPC 307/10.1

(57) ABSTRACT

An electric vehicle inverter device, the device comprising an inverter and a smoothing capacitor which are connected in parallel with a high voltage power supply. A fast discharge resistor and a discharge switch element are connected in parallel with the smoothing capacitor, and a control device controls the discharge switch element. The control device duty controls switching of the discharge switch element so that, in response to a fast discharge command, a duty ratio increases with a decrease in a voltage at both ends of the smoothing capacitor.

### INCORPORATION BY REFERENCE

The disclosure of Japanese Patent Application No. 2012-053823 filed on Mar. 9, 2012 including the specification, drawings and abstract is incorporated herein by reference in its entirety.

### BACKGROUND OF THE INVENTION

The present disclosure relates to electric vehicle inverter devices.

### DESCRIPTION OF THE RELATED ART

Conventionally, electric vehicle inverter devices are known which discharge electric charge stored in a main circuit capacitor (smoothing capacitor) by using a forced discharge circuit unit (see, e.g., Japanese Patent Application Publication No. 2010-193691 (JP 2010-193691 A)).

### SUMMARY OF THE INVENTION

When vehicle collision, etc. occurs, the voltage at both ends of the smoothing capacitor of the inverter device needs to be reduced to a target voltage within a predetermined time. In this case, in the configuration in which the smoothing capacitor is merely electrically connected to a fast discharge resistor as in the configuration described in JP 2010-193691 A, power that is consumed by the fast discharge resistor exponentially decreases with time with a peak at the start of the electrical connection (at the start of fast discharge). Thus, a problem arises that a large resistive element having (steady) rated power that allows the resistive element to withstand the initial peak power is required as a fast discharge resistor.

It is an object of the present disclosure to provide an electric vehicle inverter device capable of implementing necessary discharge of a smoothing capacitor by a fast discharge resistor and achieving reduction in size of the fast discharge resistor.

According to one aspect of the present disclosure, an electric vehicle inverter device is provided which includes: an inverter and a smoothing capacitor which are connected in parallel with a high voltage power supply; a fast discharge resistor and a discharge switch element which are connected in parallel with the smoothing capacitor; and a control device that controls the discharge switch element. In the electric vehicle inverter device, the control device duty controls switching of the discharge switch element so that a duty ratio increases with a decrease in a voltage at both ends of the smoothing capacitor, in response to a fast discharge command.

According to the aspect of the present disclosure, an electric vehicle inverter device is provided which is capable of implementing necessary discharge of a smoothing capacitor by a fast discharge resistor and achieving reduction in size of the fast discharge resistor.

### BRIEF DESCRIPTION OF THE DRAWINGS

FIG. 1 is a diagram showing an example of an overall configuration of an electric vehicle motor drive system 1;

FIG. 2 is a diagram showing an example of a main configuration of a fast discharge control device 60;

FIGS. 3A and 3B show diagrams showing waveforms of power in a fast discharge resistor R1 during fast discharge and an example of a waveform of a voltage at both ends of a smoothing capacitor C according to an embodiment.

FIGS. 4A to 4C show enlarged diagrams of portions Y1 to Y3 of the waveform shown in FIG. 3A;

FIGS. 5A and 5B show diagrams showing a waveform of power in the fast discharge resistor R1 during fast discharge and an example of a waveform of the voltage at both ends of the smoothing capacitor C according to a comparative example;

FIG. 6 is a diagram showing a specific configuration of a fast discharge control device 60A according to an embodiment;

FIGS. 7A to 7C show waveform charts (first example) illustrating a discharge operation that is implemented by the fast discharge control device 60A shown in FIG. 6;

FIGS. 8A to 8C show waveform charts (second example) illustrating the discharge operation realized by fast discharge control unit 60A shown in FIG. 6;

FIG. 9 is a diagram showing a specific configuration of a fast discharge control device 60B according to another embodiment;

FIG. 10 is a diagram showing various waveforms illustrating the operation of a variable duty generation circuit 64B;

FIG. 11 is a diagram (first example) illustrating principles in which the duty ratio increases with a decrease in the voltage Vc at both ends of the smoothing capacitor C;

FIG. 12 is a diagram (second example) illustrating the principles in which the duty ratio increases with a decrease in the voltage Vc at both ends of the smoothing capacitor C;

FIG. 13 is a diagram (third example) illustrating the principles in which the duty ratio increases with a decrease in the voltage Vc at both ends of the smoothing capacitor C;

FIG. 14 is a diagram showing the relation between the voltage Vc at both ends of the smoothing capacitor C and the duty ratio when the variable duty generation circuit 64B is operated; and

FIGS. 15A to 15C show waveform charts illustrating a discharge operation that is implemented by the fast discharge control device 60B shown in FIG. 9.

### MODES FOR CARRYING OUT THE INVENTION

Embodiments will be described below with reference to the accompanying drawings.

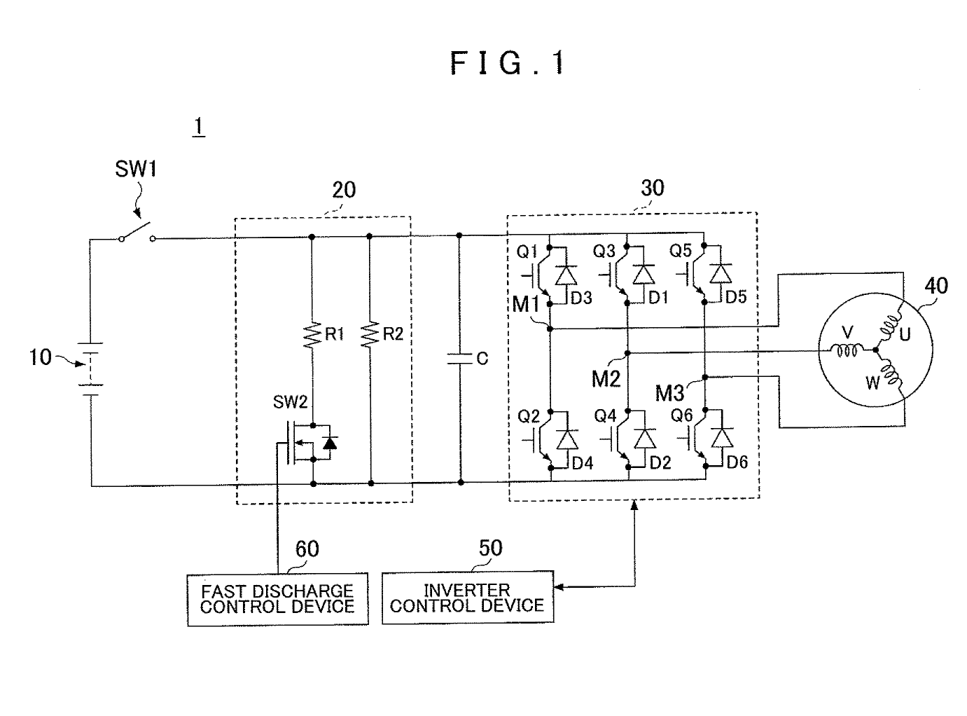

FIG. 1 is a diagram showing an example of the overall configuration of an electric vehicle motor drive system 1. The motor drive system 1 is a system that drives a vehicle by driving a drive motor 40 by using electric power of a high voltage battery 10. The specific type and configuration of an electric vehicle are not limited as long as the electric vehicle runs by driving the drive motor 40 with electric power. Typical examples of the electric vehicle include a hybrid vehicle (HV) having an engine and the drive motor 40 as power sources, and an electric vehicle having only the drive motor 40 as a power source.

As shown in FIG. 1, the motor drive system 1 includes the high voltage battery 10, an inverter 30, the drive motor 40, and an inverter control device 50.

The high voltage battery 10 is any electricity storage device that stores electric power and outputs a direct current (DC) voltage, and may be formed by a nickel hydrogen battery, a lithium ion battery, or a capacitive element such as an electric double layer capacity. The high voltage battery 10 is typically a battery having a rated voltage exceeding 100 V, and the rated voltage may be, e.g., 288 V.

An inverter 30 is formed by U, V, and W-phase arms arranged in parallel between a positive electrode line and a negative electrode line. The U-phase arm is formed by series connection of switching elements (in this example, insulated gate bipolar transistors (IGBTs)) Q1, Q2, the V-phase arm is formed by series connection of switching elements (in this example, IGBTs) Q3, Q4, and the W-phase arm is formed by series connection of switching elements (in this example, IGBTs) Q5, Q6. Diodes D1 to D6 are placed between the collector and the emitter of the switching elements Q1 to Q6, respectively, so as to allow a current to flow from the emitter side to the collector side. The switching elements Q1 to Q6 may be switching elements other than the IGBTs, such as metal oxide semiconductor field-effect transistors (MOSFETs).

The drive motor 40 is a three-phase alternating current (AC) motor, and one end of each of the three coils of U, V, and W phases is connected to a common middle point. The other end of the U-phase coil is connected to a middle point M1 between the switching elements Q1, Q2, the other end of the V-phase coil is connected to a middle point M2 between the switching elements Q3, Q4, and the other end of the W-phase coil is connected to a middle point M3 between the switching elements Q5, Q6. A smoothing capacitor C is connected between the collector of the switching element Q1 and the negative electrode line.

The inverter control device 50 controls the inverter 30. The inverter control device 50 includes, e.g., a CPU, a ROM, a main memory, and the inverter control device 50 performs its various functions by reading a control program recorded on the ROM, etc. onto the main memory and performing the control program by the CPU. The inverter 30 can be controlled by any method, but is basically controlled such that the two switching elements Q1, Q2 of the U phase turn on/off in opposite phases to each other, the two switching elements Q3, Q4 of the V phase turn on/off in opposite phases to each other, and that the two switching elements Q5, Q6 of the W phase turn on/off in opposite phases to each other.

Although the motor drive system 1 has the single drive motor 40 in the example shown in FIG. 1, the motor drive system 1 may have an additional motor (including an electric generator). In this case, the additional motor (one or more) together with a corresponding inverter may be connected to the high voltage battery 10 in parallel with the drive motor 40 and the inverter 30. Although the motor drive system 1 includes no DC-DC converter in the example of FIG. 1, the motor drive system 1 may include a DC-DC converter between the high voltage battery 10 and the inverter 30.

As shown in FIG. 1, a cut-off switch SW1 that cuts off power supply from the high voltage battery 10 is provided between the high voltage battery 10 and the smoothing capacitor C. The cut-off switch SW1 may be formed by a semiconductor switch, a relay, etc. The cut-off switch SW1 is on in a normal state, and is turned off upon, e.g., detection of vehicle collision. Switching of the cut-off switch SW1 may be implemented by the inverter control device 50, or may be implemented by other control devices.

The motor drive system 1 further includes a discharge circuit 20. As shown in FIG. 1, the discharge circuit 20 is connected in parallel with the smoothing capacitor C. The discharge circuit 20 includes a fast discharge resistor R1 and a discharge switch element SW2, and a normal discharge resistor R2. The fast discharge resistor R1 and the discharge switch element SW2, and the normal discharge resistor R2 are connected in parallel with the smoothing capacitor C. Although the discharge circuit 20 is placed between the high voltage battery 10 (and the cut-off switch SW1) and the smoothing capacitor C in the example shown in FIG. 1, the discharge circuit 20 may be placed at any position on a smoothing capacitor C side with respect to the cut-off switch SW1. Accordingly, the discharge circuit 20 may be placed between the smoothing capacitor C and the inverter 30. The fast discharge resistor R1 and the discharge switch element SW2, and the normal discharge resistor R2 need not necessarily be arranged in pair. For example, the fast discharge resistor R1 and the discharge switch element SW2, and the normal discharge resistor R2 may be arranged on both sides of the smoothing capacitor C, respectively.

As shown in FIG. 1, the discharge switch element SW2 of the discharge circuit 20 is connected in series with the fast discharge resistor R1 between the positive electrode line and the negative electrode line. The discharge switch element SW2 may have any configuration as long as it can be controlled by duty control described later. However, the discharge switch element SW2 is preferably a semiconductor switching element. Although the discharge switching element SW2 is a MOSFET in the illustrated example, the discharge switching element SW2 may be other semiconductor switching elements (e.g., an IGBT).

The discharge switching element SW2 of the discharge circuit 20 is controlled by a fast discharge control device 60. The fast discharge control device 60 may be implemented by any hardware, software, firmware, or any combination thereof. For example, any part or all of the functions of the fast discharge control device 60 may be implemented by an application-specific integrated circuit (ASIC) or a field programmable gate array (FPGA). Alternatively, any part or all of the functions of the fast discharge control device 60 may be implemented by the inverter control device 50 or other control devices. A method of controlling the discharge switch element SW2 by the fast discharge control device 60 will be described in detail later.

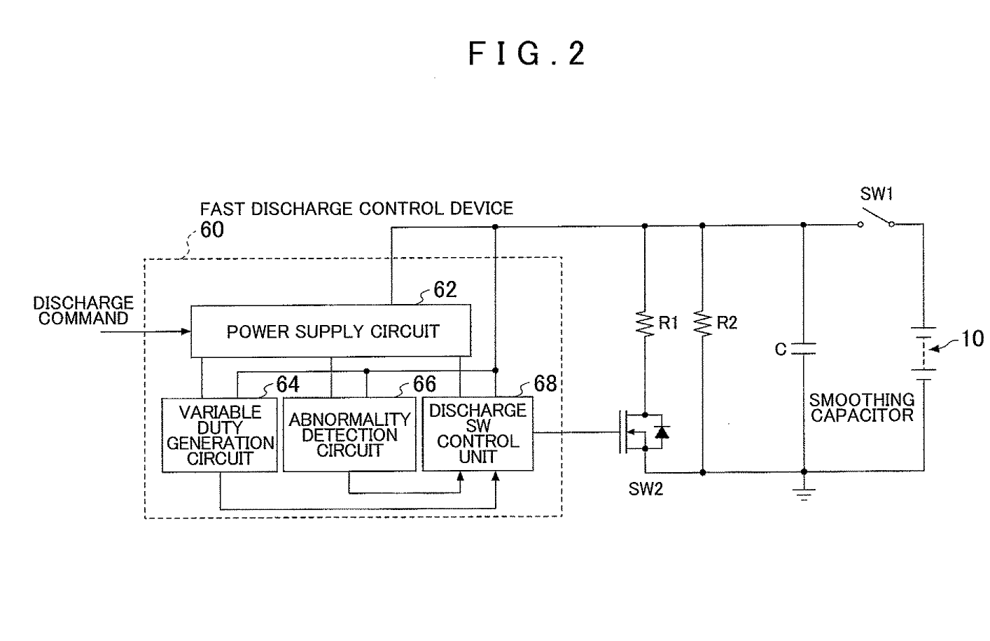

FIG. 2 is a diagram showing an example of a main configuration of the fast discharge control device 60. FIG. 2 shows the components associated with the fast discharge control device 60 in the circuit shown in FIG. 1.

As shown in FIG. 2, the fast discharge control device 60 includes a power supply circuit 62, a variable duty generation circuit 64, an abnormality detection circuit 66, and a discharge SW control unit 68.

A discharge command is externally input to the power supply circuit 62. The discharge command is typically input when vehicle collision is detected or when it is determined that vehicle collision is unavoidable. The discharge command may be supplied from an air bag ECU, a pre-crash ECU, etc. that control a safety device (e.g., an air bag) of the vehicle. In response to the discharge command, the power supply circuit 62 generates a power supply voltage by using a voltage between both ends of the smoothing capacitor C (namely, electric charge stored in the smoothing capacitor C from the high voltage battery 10 before reception of the discharge command). The power supply voltage thus generated by the power supply circuit 62 is preferably used for operation of the variable duty generation circuit 64, the abnormality detection circuit 66, and the discharge SW control unit 68. This eliminates the need for interconnection from a low voltage battery, and thus can avoid inconvenience that is caused in the case of using the interconnection from the low voltage battery (e.g., the interconnection is disconnected upon vehicle collision, disabling the operation of the variable duty generation circuit 64, the abnormality detection circuit 66, and the discharge SW control unit 68). Basically (unless there is abnormality such as fixing of the cut-off switch SW1), in the case where the discharge command is generated, the cut-off switch SW1 is opened, quickly creating a state where the high voltage battery 10 is disconnected.

The variable duty generation circuit 64 generates an on/off signal (pulse signal) that turns on/off the discharge switch element SW2 by duty control. The variable duty generation circuit 64 may be a circuit that is activated in response to power supply from the power supply circuit 62. When an on signal is generated by the variable duty generation circuit 64 (i.e., in an on period of the on/off signal), the discharge switch element SW2 is turned on (electrically connected) via the discharge SW control unit 68, whereby discharge of the smoothing capacitor C by the fast discharge resistor R1 is implemented. When an off signal is generated (i.e., in an off period of the on/off signal), the discharge switch element SW2 is turned off via the discharge SW control unit 68, whereby discharge of the smoothing capacitor C by the fast discharge resistor R1 is not performed. The variable duty generation circuit 64 generates the on/off signal while varying the duty ratio (on time/one cycle of the pulse signal). In this case, the variable duty generation circuit 64 generates the on/off signal so that the duty ratio increases as the voltage at both ends of the smoothing capacitor C decreases. Such a variable duty can be generated by various methods, and any method can be used. For example, the variable duty generation circuit 64 may generate an on/off signal whose duty ratio is determined according to the voltage at both ends of the smoothing capacitor C, based on the fact that the voltage at both ends of the smoothing capacitor C gradually decreases as discharge of the smoothing capacitor C progresses after the start of fast discharge. Alternatively, the variable duty generation circuit 64 may generate an on/off signal whose duty ratio is determined according to the elapsed time since the start of fast discharge, based on the fact that the voltage at both ends of the smoothing capacitor C gradually decreases as discharge of the smoothing capacitor C progresses after the start of fast discharge. Some examples of a method for generating a variable duty (configuration examples of the variable duty generation circuit 64) will be described later.

The abnormality detection circuit 66 forcibly turns off the discharge switch element SW2 if a predetermined condition is satisfied after the start of discharge. For example, the predetermined condition may be the case where the voltage at both ends of the smoothing capacitor C has a predetermined value or more even after a predetermined time has passed since the start of fast discharge. This is assumed to occur when the cut-off switch SW1 is closed even though a discharge command has been generated due to any abnormality (e.g., the case where the cut-off switch SW1 has been fixed in the on state). In this case, even if the smoothing capacitor C is being discharged by the fast discharge resistor R1, the voltage at both ends of the smoothing capacitor C does not decrease because the high voltage battery 10 is kept in the connected state. Accordingly, the discharge switch element SW2 is forcibly turned off upon detection of such a state. This can prevent prolonged energy loss due to continued discharge of the smoothing capacitor C by the fast discharge resistor R1 (and continued unnecessary consumption of power from the high voltage battery 10) even if a discharge command is accidentally generated due to, e.g., noise. Alternatively, the predetermined condition may be, e.g., the case where a predetermined time has passed since the start of fast discharge. In this case, the predetermined time may correspond to the time it takes for the voltage at both ends of the smoothing capacitor C to decrease to a predetermined target voltage in the case where the cut-off switch SW1 is opened normally in response to a discharge command (or the sum of this time and a predetermined margin), and may be adapted by a test, etc. This can also avoid the above disadvantage in the case where a discharge command is accidentally generated due to noise, etc.

The discharge SW control unit 68 implements switching of the discharge switch element SW2 based on the on/off signal from the variable duty generation circuit 64.

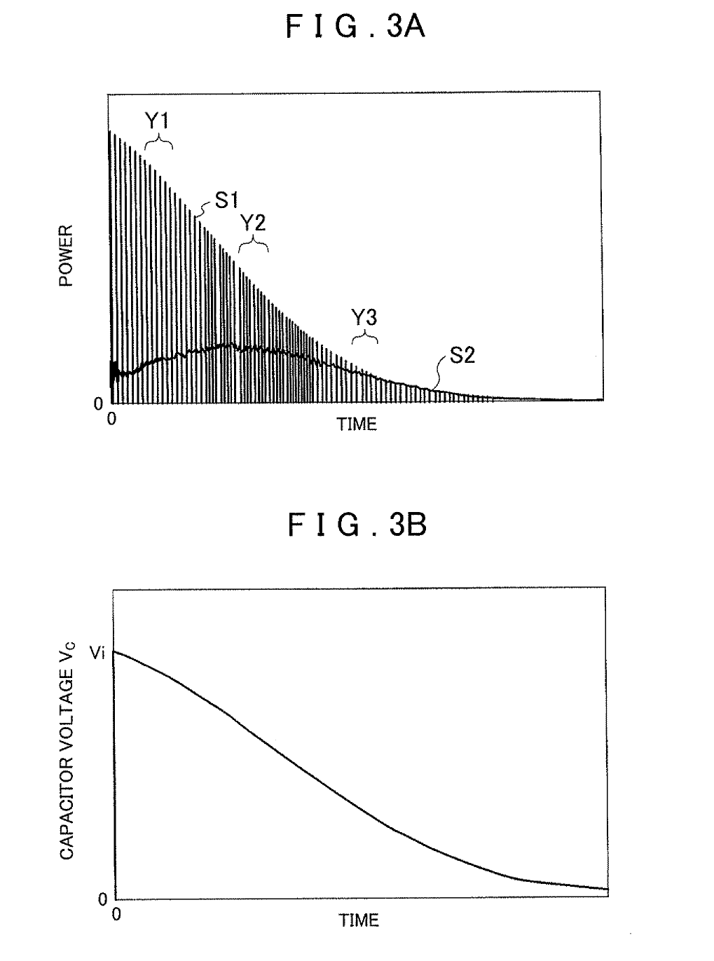

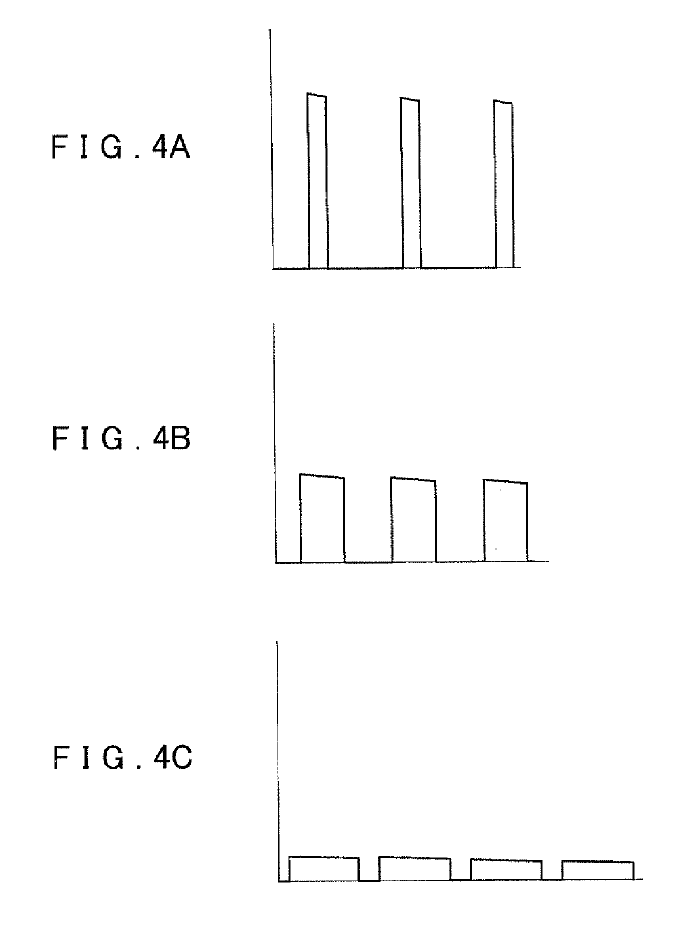

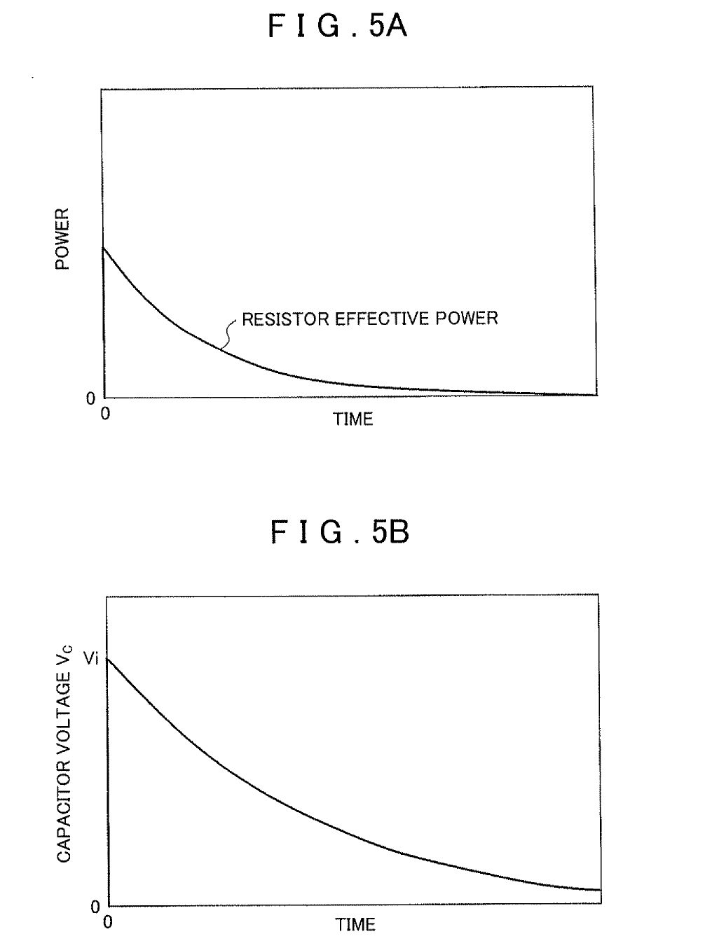

FIGS. 3A and 3B show a manner in which fast discharge is performed in the present embodiment. FIG. 3A is a diagram showing waveforms of power in the fast discharge resistor R1 during fast discharge, and FIG. 3B is a diagram showing an example of a waveform of the voltage at both ends of the smoothing capacitor C. FIGS. 4A to 4C show enlarged diagrams of portions Y1 to Y3 of the waveform shown in FIG. 3A. FIGS. 5A and 5B show a manner in which fast discharge is performed in a comparative example. FIG. 5A is a diagram showing a waveform of power in the fast discharge resistor during fast discharge, and FIG. 5B is a diagram showing an example of a waveform of the voltage at both ends of the smoothing capacitor C.

FIG. 3A shows two waveforms, namely a waveform S1 of resistor instantaneous power and a waveform S2 of resistor effective power, where the abscissa represents time, and the ordinate represents power. FIGS. 4A to 4C show enlarged diagrams of various portions (portions Y1 to Y3) of the waveform of the resistor instantaneous power in FIG. 3A. The resistor instantaneous power refers to the power that is consumed in the fast discharge resistor R1 instantaneously (e.g., during on time of the on/off signal having a minimum duty ratio). The resistor effective power refers to the power that is consumed in the fast discharge resistor R1 per time significantly longer than the time period for the resistor instantaneous power (e.g., per cycle of the on/off signal). FIG. 5A shows a waveform of resistor effective power, where the abscissa represents time and the ordinate represents power. FIGS. 3B and 5B show waveforms of the voltage at both ends of the smoothing capacitor C, where the abscissa represents time, and the ordinate represents voltage. FIGS. 3A and 3B and FIGS. 5A and 5B have a common time axis. FIGS. 3A and 5A have a common scale on the ordinate, and FIGS. 3B and 5B have a common scale on the ordinate.

In the present embodiment and the comparative example, the state at the start of fast discharge (the voltage at both ends of the smoothing capacitor C) is under the same conditions. In the present embodiment and the comparative example, the size of the fast discharge resistor R1 is determined so that the voltage at both ends of the smoothing capacitor C decreases to a predetermined target voltage before a predetermined time passes after the start of fast discharge. Each of the predetermined time and the predetermined target voltage may be a value that is determined according to a law, a regulation, etc.

The comparative example shown in FIGS. 5A and 5B is a configuration in which the discharge switch element SW2 is constantly on (i.e., the duty ratio is constantly 1) during fast discharge. In this case, as shown in FIGS. 5A and 5B, the resistor effective power has a peak value at the start of fast discharge as the voltage at both ends of the smoothing capacitor C is the highest (maximum voltage Vi). Then, the voltage at both ends of the smoothing capacitor C and the resistor effective power gradually decrease as discharge of the smoothing capacitor C progresses (as time passes). In this comparative example, the size of the fast discharge resistor R1 is determined based on the highest resistor effective power at the start of fast discharge (i.e., the voltage at both ends of the smoothing capacitor C at the start of fast discharge). That is, in this comparative example, since the steady maximum voltage Vi is applied to the fast discharge resistor R1 at the start of fast discharge, a large resistive element having such a (steady) rated voltage that allows the resistive element to withstand the maximum voltage Vi is required as the fast discharge resistor R1.

In addition to the (steady) rated voltage at which the resistive element can withstand continuous load, the resistive element has a rated pulse voltage at which the resistive element can withstand load only for a short time (e.g., about 10 ms). This rated pulse voltage is higher than the (steady) rated voltage, and the shorter the pulse duration is, the higher the value of the rated pulse voltage is. More specifically, the rated voltage E and the rated pulse voltage Ep can be represented by the following expressions.

E=\sqrt{(P·R)}

Ep={square root over ((P·R·T/τ)}

In the expressions, P represents rated power, R represents a rated resistance value, τ represents pulse duration, and T represents a pulse period (one cycle of the on/off signal).

In this regard, in the present embodiment, the discharge switch element SW2 is duty controlled during fast discharge, and the duty ratio in that case is set so as to increase as the voltage at both ends of the smoothing capacitor C decreases. Thus, as shown in FIG. 3A and FIGS. 4A to 4C, the resistor instantaneous power is larger than that in the comparative example (which is substantially equal to the resistor effective power in the comparative example), but the peak value of the resistor effective power can be suppressed to a value that is the same as or less than that of the resistor effective power in the comparative example. That is, in the present embodiment, the maximum voltage Vi similar to that of the comparative example is applied to the fast discharge resistor R1 at the start of fast discharge. However, the maximum voltage Vi is not steadily applied as in the comparative example but is applied for a very short time (i.e., on time of the on/off signal; 10 ms or less). Accordingly, an effective value of the applied voltage can be reduced. Thus, any resistor whose maximum voltage Vi is lower than the rated pulse voltage can be used as the fast discharge resistor R1, and the size of the fast discharge resistor R1 can be reduced accordingly. That is, according to the present embodiment, the discharge switch element SW2 is duty controlled during fast discharge, and thus, the size of the fast discharge resistor R1 can be determined based on the rated pulse voltage higher than the rated voltage, whereby the size of the fast discharge resistor R1 can be reduced. In the present embodiment, in view of the fact that the voltage at both ends of the smoothing capacitor C is the highest at the start of fast discharge, and then decreases gradually, the duty ratio is set so as to increase as the voltage at both ends of the smoothing capacitor C decreases. Thus, according to the present embodiment, the rated pulse voltage can be uniformly increased during the entire fast discharge period, whereby the size of the fast discharge resistor R1 can be reduced and necessary discharge capacity (resistor effective power) can be ensured.

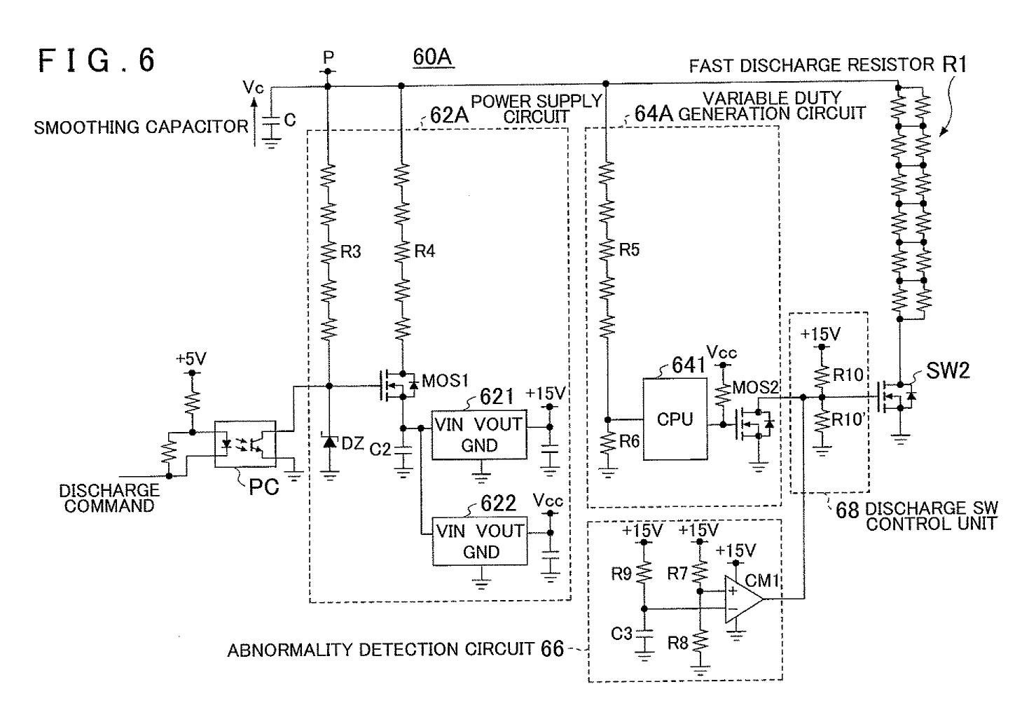

FIG. 6 is a diagram showing a specific configuration of a fast discharge control device 60A according to an embodiment. As shown in FIG. 6, the fast discharge control unit 60A includes a power supply circuit 62A, a variable duty generation circuit 64A, an abnormality detection circuit 66, and a discharge SW control unit 68. In the diagram showing in FIG. 6, a power source P represents the positive electrode side of the high voltage battery 10.

The power supply circuit 62A is connected in parallel with the smoothing capacitor C. The power supply circuit 62A generates a constant voltage (in this example, +15 V and Vcc of, e.g., +5 V) by using the voltage of the smoothing capacitor C (discharge from the smoothing capacitor C). The power supply circuit 62A includes a switching element MOS1 formed by a MOSFET, a Zener diode DZ, resistors R3, R4, and voltage regulators (3-terminal regulators) 621, 622. The drain of the switching element MOS1 is connected to the positive electrode side of the smoothing capacitor C via the resistor R4, and the source of the switching element MOS1 is connected to the ground via a capacitor C2. The gate of the switching element MOS1 is connected between the resistor R3 and the Zener diode DZ which are series connected between the positive electrode side and the ground. If a discharge command is generated, a constant voltage is applied to the gate of the switching element MOS1 by the Zener diode DZ, and the switching element MOS1 operates as a linear regulator. Thus, a voltage of, e.g., about 17 V is generated at input terminals of the voltage regulators 621, 622, and a constant voltage (in this example, +15 V and Vcc) is generated by the voltage regulators 621, 622. As shown in FIG. 6, this constant voltage is used in the variable duty generation circuit 64A, the abnormality detection circuit 66, and the discharge SW control unit 68. In the illustrated example, the discharge command is input to the power supply circuit 62A via a photo coupler PC.

The variable duty generation circuit 64A includes a CPU 641, resistors R5, R6, and a switching element MOS2. The voltage obtained by dividing the voltage at both ends of the smoothing capacitor C by the resistors R5, R6 is input to the CPU 641, The CPU 641 produces an on/off signal so that the duty ratio increases as the voltage Vc at both ends of the smoothing capacitor C (capacitor voltage Vc) decreases, based on the divided voltage value of the voltage at both ends of the smoothing capacitor C. In this example, the CPU 641 sets the duty ratio so that the duty ratio increases in inverse proportion to the square of the voltage Vc at both ends of the smoothing capacitor C. That is, the duty ratio ∝1/Vc². The on/off signal (in this example, low/high level) is generated by using the power supply voltage Vcc generated in the power supply circuit 62A, and is applied to the gate of the switching element MOS2. The drain of switching element MOS2 is connected to the discharge SW control unit 68, and the source of the switching element MOS2 is connected to the ground. In the off period of the duty control, a high level voltage_is applied to the gate of the switching element MOS2, and the switching element MOS2 is turned on. In the on period of the duty control, a low level voltage_is applied to the gate of the switching element MOS2, and the switching element MOS2 is turned off. The CPU 641 may generate an on/off signal whose duty ratio increases as the voltage Vc at both ends of the smoothing capacitor C decreases in any manner. For example, the duty ratio may be set to increase in proportion to a decrease from the voltage Vi at both ends of the smoothing capacitor C at the start of fast discharge (Vi−Vc). That is, the duty ratio ∝a+b (Vi−Vc), where a and b represent predetermined coefficients.

The abnormality detection circuit 66 includes a comparator CM1, resistors R7, R8, R9, and a capacitor C3. The comparator CM1 has an open collector output. The voltage of the capacitor C3 that is charged via the resistor R9 by the power supply voltage of +15 V generated by the power supply circuit 62A is input to an inverting input terminal of the comparator CM1. The voltage obtained by dividing the power supply voltage of +15 V (the power supply voltage of +15 V generated by the power supply circuit 62A) by the resistors R7, R8 is input to a non-inverting input terminal of the comparator CM1. The comparator CM 1 uses as a single power source the power supply voltage of +15 V generated by the power supply circuit 62A. If a discharge command is generated, the power supply voltage of +15 V is generated by the power supply circuit 62A, and thus the voltage of the capacitor C3 increases according to an exponential curve that is determined by a time constant C3·R9. While the voltage of the capacitor C3 is lower than the voltage obtained by dividing the power supply voltage of +15 V by the resistors R7, R8, the output of the comparator CM1 is at a high level. If the voltage of the capacitor C3 becomes higher than the voltage obtained by dividing the power supply voltage of +15V by the resistors R7, R8, the output of the comparator CM1 falls to a low level. Accordingly, the output of the comparator CM1 changes from the high level to the low level when predetermined time passes after generation of the discharge command.

The discharge SW control unit 68 includes resisters R10, R10′ connected in series between the power supply voltage of +15 V that is generated by the power supply circuit 62A and the ground. The drain of the switching element MOS2 and the output of comparator CM1 are connected between the resistors R10, R10′, and the gate of the discharge switch element SW2 (in this example, MOSFET) is also connected between the resistors R10, R10′. When the switching element MOS2 is off and the output of the comparator CM1 is at the high level, the voltage obtained by dividing the power supply voltage of +15 V by the resistors R10, R10′ is applied to the gate of the discharge switch element SW2, and the discharge switch element SW2 is turned on. On the other hand, when the switching element MOS2 is on or the output of the comparator CM1 is at the low level, the gate of the discharge switch element SW2 has the ground potential (0 V), and the discharge switch element SW2 is turned off.

As described above, in the example shown in FIG. 6, while the output of the comparator CM1 of the abnormality detection circuit 66 is at the high level, the discharge switch element SW2 is turned on/off according to the on/off state of the switching element MOS2 at a duty ratio corresponding to that of the on/off signal from the variable duty generation circuit 64A.

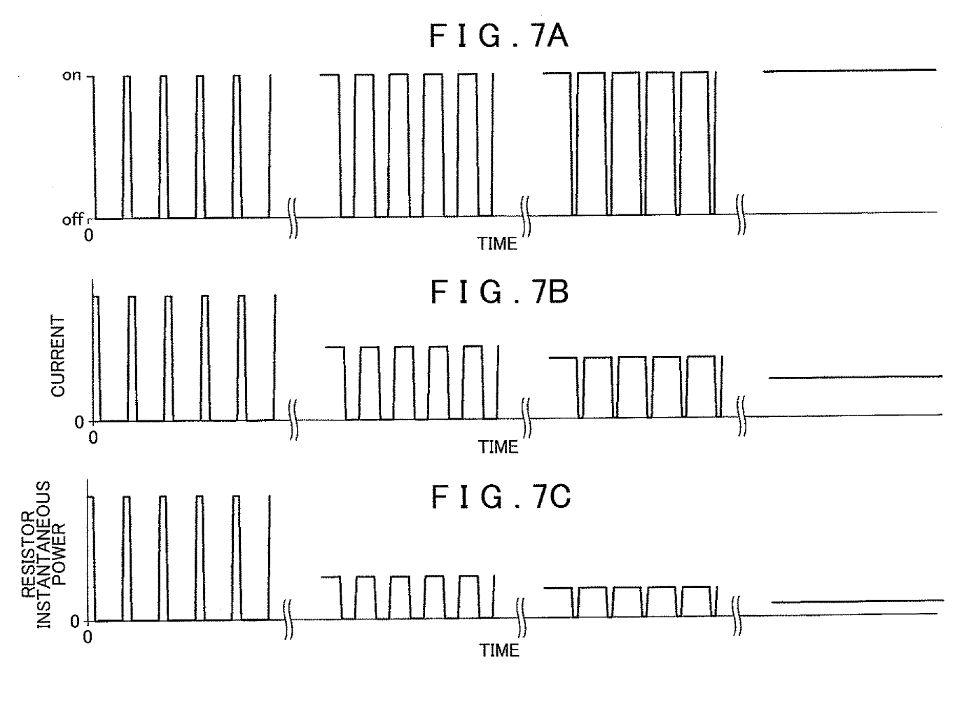

FIGS. 7A to 7C show waveform charts (first example) illustrating a discharge operation that is implemented by the fast discharge control device 60A shown in FIG. 6. FIG. 7A shows a waveform of the on/off state of the discharge switch element SW2 in time series, FIG. 7B shows in the same time series a waveform of a current flowing through the fast discharge resistor R1, and FIG. 7C shows in the same time series a waveform of the resistor instantaneous power that is instantaneously consumed by the fast discharge resistor R1.

As shown in FIGS. 7A to 7C, in the present embodiment, the voltage Vc at both ends of the smoothing capacitor C is high at the start of fast discharge, and thus the duty ratio is low. Accordingly, the on time of the discharge switch element SW2 is short. As a matter of course, the current flowing in the fast discharge resistor R1 and the resistor instantaneous power have a value only during the on period of the discharge switch element SW2, and are 0 during the remaining period. The duty ratio starts to increase when fast discharge of the smoothing capacitor C progresses and the voltage Vc at both ends of the smoothing capacitor C decreases (toward the right side in the figure). As shown in FIGS. 7B and 7C, as the voltage Vc at both ends of the smoothing capacitor C decreases, the values of both the current flowing in the fast discharge resistor R1 and the resistor instantaneous power become smaller. However, as the on period increases, the time during which the current flows in the fast discharge resistor R1 increases, and an integral value of the resistor instantaneous power (corresponding to “power peak value×duty ratio,” i.e., the resistor effective power) becomes substantially constant until the duty ratio reaches 1.

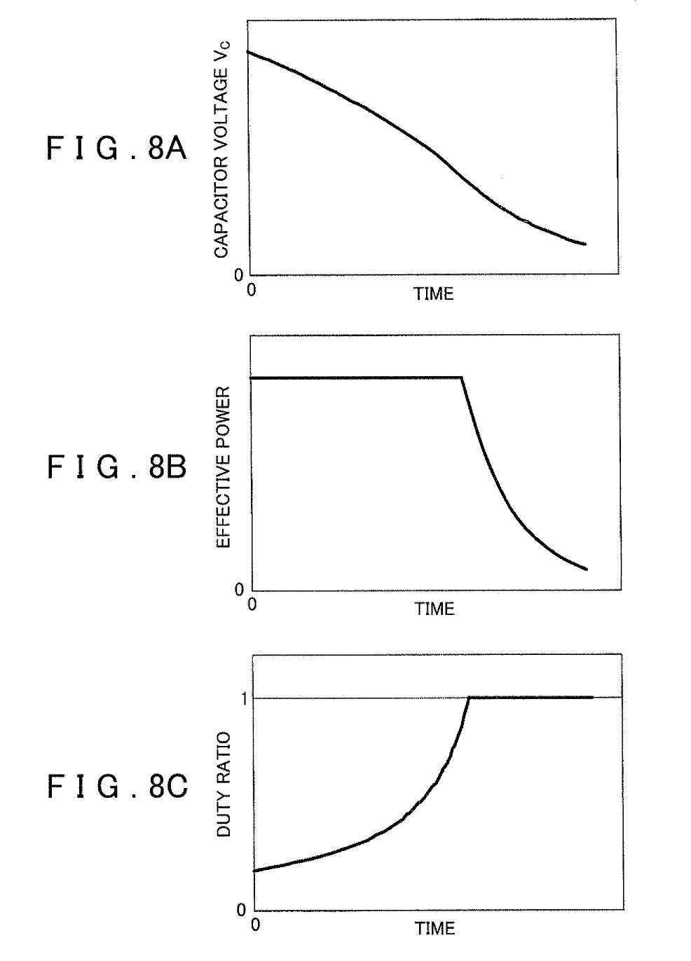

FIGS. 8A to 8C show waveform charts (second example) illustrating a discharge operation that is implemented by the fast discharge control device 60A shown in FIG. 6. FIG. 8A shows a waveform of the voltage Vc at both ends of the smoothing capacitor C in time series, FIG. 8B shows in the same time series a waveform of the resistor effective power in the fast discharge resistor R1, and FIG. 8C shows in the same time series a waveform of the duty ratio of the discharge switch element SW2.

As shown in FIG. 8C, in this example, the duty ratio is set so as to increase from a small value (e.g., around 0.2) to 1 in inverse proportion to the square of the voltage Vc at both ends of the smoothing capacitor C. Accordingly, as shown in FIG. 8B, the resistor effective power (power peak value×duty ratio) is substantially constant until the duty ratio reaches 1. As shown in FIG. 8A, the voltage Vc at both ends of the smoothing capacitor C gradually decreases by the discharge via the fast discharge resistor R1, and is reduced to a predetermined target voltage within a predetermined time from the start of fast discharge.

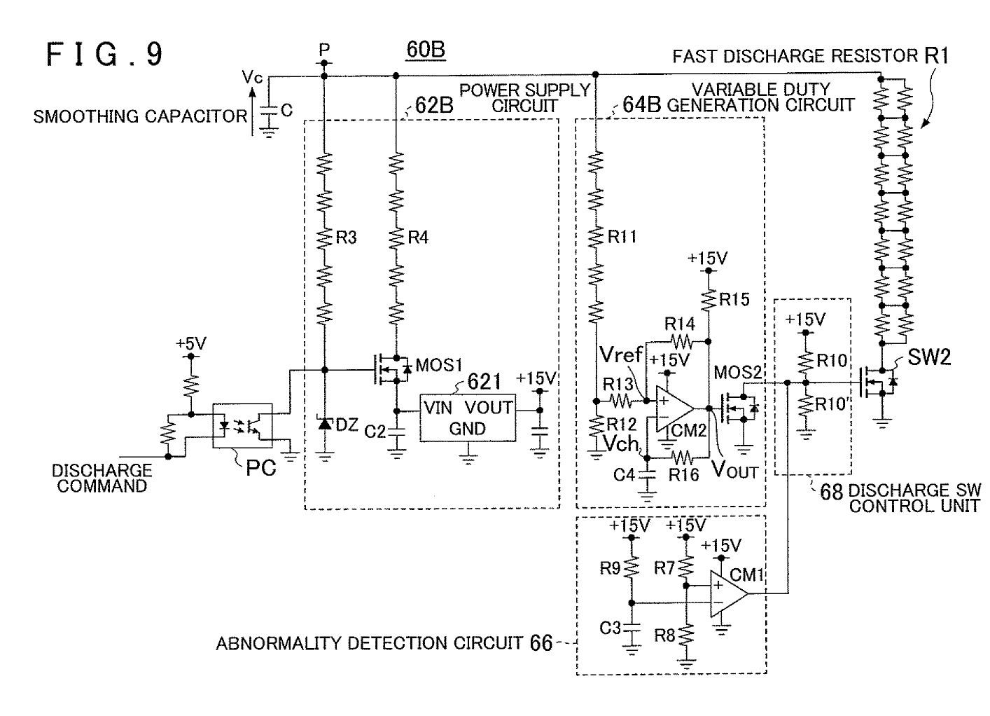

FIG. 9 is a diagram showing a specific configuration of a fast discharge control device 60B according to another embodiment. As shown in FIG. 9, the fast discharge control device 60B includes a power supply circuit 62B, a variable duty generation circuit 64B, an abnormality detection circuit 66, and a discharge SW control unit 68. The abnormality detection circuit 66 and the discharge SW control unit 68 may be similar to the abnormality detection circuit 66 and the discharge SW control unit 68 of the fast discharge control device 60A described above with reference to FIG. 6.

The power supply circuit 62B is connected in parallel with the smoothing capacitor C. The power supply circuit 62B generates a constant voltage (in this example, +15 V) by using the voltage of the smoothing capacitor C. The power supply circuit 62B includes a switching element MOS1 formed by a MOSFET, a Zener diode DZ, resistors R3, R4, and a voltage regulator 621. The drain of the switching element MOS1 is connected to the positive electrode side of the smoothing capacitor C via the resistor R4, and the source of the switching element MOS1 is connected to the ground via a capacitor C2. The gate of the switching element MOS1 is connected between the resistor R3 and the Zener diode DZ which are series connected between the positive electrode side and the ground. If a discharge command is generated, a constant voltage is applied to the gate of the switching element MOS1 by the Zener diode DZ, and the switching element MOS1 operates as a linear regulator. Thus, a voltage of, e.g., about 17 V is generated at an input terminal of the voltage regulator 621, and a constant voltage (in this example, +15 V) is generated by the voltage regulator 621. As shown in FIG. 9, this constant voltage is used in the variable duty generation circuit 64B, the abnormality detection circuit 66, and the discharge SW control unit 68.

The variable duty generation circuit 64B includes a comparator CM2, resistors R11, R12, R13, R14, R15, R16, a capacitor C4, and a switching element MOS2. The resisters R11, R12 are connected in series between the positive electrode side of the smoothing capacitor C and the ground, and a non-inverting input terminal of the comparator CM2 is connected between the resistors R11, R12 via the resister R13. The comparator CM2 has an open collector output. A power supply voltage of +15 V is connected between the resister R13 and the non-inverting input terminal of the comparator CM2 via the resisters R14, R15. The resisters R15, R16 and the capacitor C4 are connected in series between the power supply voltage of +15 V and the ground. An inverting input terminal of the comparator CM2 is connected between the capacitor C4 and the resister R16. The output of the comparator CM2 is connected between the resisters R15, R16, and is connected to the gate of the switching element MOS2. As described below, the variable duty generation circuit 64B generates an on/off signal having a duty ratio that increases substantially in proportion to a decrease from the voltage Vi at both ends of the smoothing capacitor C at the start of fast discharge (Vi−Vc). That is, the duty ratio ∝a+b (Vi−Vc), where a and b represent predetermined coefficients. The on/off signal (in this example, low/high level) is generated by using the power supply voltage of +15 V that is generated in the power supply circuit 62B, and is applied to the gate of the switching element MOS2. The drain of the switching element MOS2 is connected to the discharge SW control unit 68, and the source of the switching element MOS2 is connected to the ground. During an off period of the duty control, a high level voltage is applied to the gate of the switching element MOS2, and the switching element MOS2 is turned on. During an on period of the duty control, a low level voltage is applied to the gate of the switching element MOS2, and the switching element MOS2 is turned off.

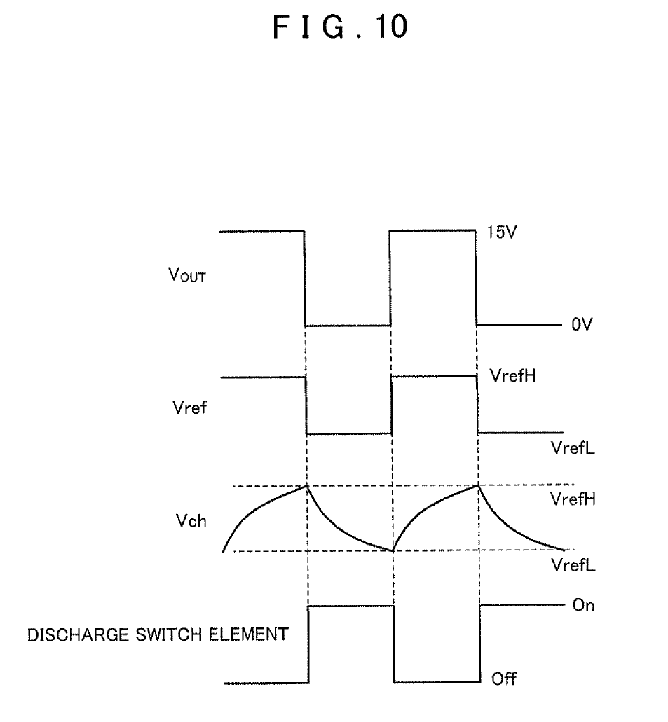

Principles of generating the on/off signal by the variable duty generation circuit 64B will be described below with reference to FIGS. 10 to 14. For simplicity of description, the resister R15 herein has a very small resistance value as compared with the other resisters R11, R12, R13, R14, R16, and is negligible. Moreover, the comparator CM2 herein has very high current sink capability at the time of a low level output, and the voltage is 0 V at the time of the low level output.

First, when V_{refH} represents the voltage Vref at the non-inverting input terminal of the comparator CM2 when the output of the comparator CM2 is at a high level, and V_{refL} represents the voltage Vref at the non-inverting input terminal of the comparator CM2 when the output of the comparator CM2 is at the low level, V_{refH} and V_{refL} can be given by the following expressions.

V_{refH}=(Vc·R12·R14+15·Ry)/Rx (1)

V_{refL}=Vc·R12·R14/Rx (2)

where Rx=R11·R12+(R13+R14)·(R11+R12) and Ry=R11·R12+R13(R11+R12). Accordingly, the difference Δref between V_{refH} and V_{refL} is given by the following expression.

Δref=15·Ry/Rx (3)

The expression (3) shows that Δref is constant regardless of the voltage Vc at both ends of the smoothing capacitor C. On the other hand, the expressions (1) and (2) show that V_{refH} and V_{refL} decrease with a decrease in the voltage Vc at both end of the smoothing capacitor C. The resistance values of R11 to R14 are set so that V_{refH} and V_{refL} satisfy the following expression even when the voltage Vc at both ends of the smoothing capacitor C is the maximum voltage Vi (the voltage at the start of fast discharge).

V_{refL}<V_{refH}<15 (4)

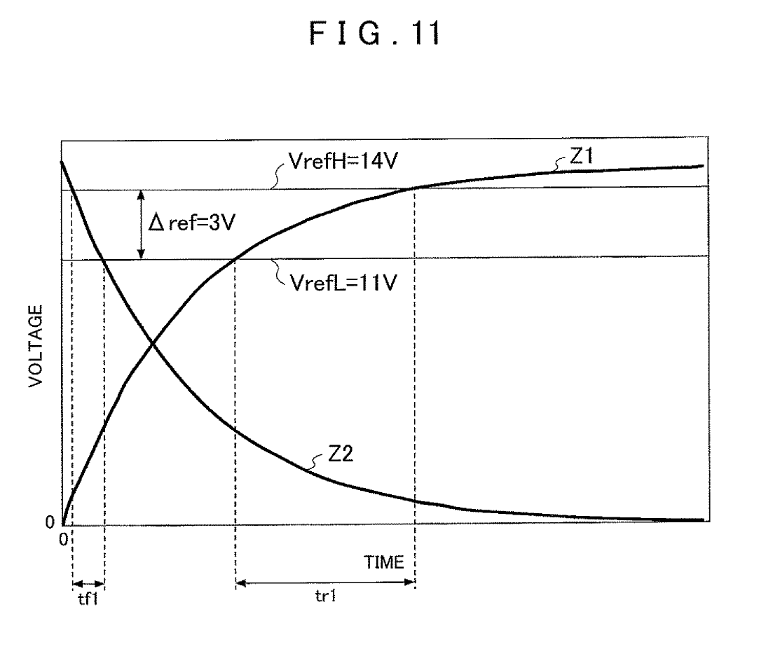

When the output Vout of the comparator CM2 is at the high level, the voltage Vch at the inverting input terminal of the comparator CM2 increases according to an exponential curve that is determined by a time constant C4·R16. When the voltage Vch increases and reaches V_{refH} the output Vout of the comparator CM2 changes to the low level (0V), and the operation of discharging the capacitor C4 is performed. Accordingly, the voltage Vch decreases according to the exponential curve that is determined by the time constants C4·R16. When the voltage Vch decreases and reaches V_{refL}, the output Vout of the comparator CM2 changes to the high level (15V), and the operation of charging the capacitor C4 is performed. Accordingly, the voltage Vch increases according to the exponential curve that is determined by the time constants C4·R16. Such a repeated operation is shown by the waveforms of FIG. 10. FIG. 10 shows, from top to bottom, a waveform of the output Vout of the comparator CM2, a waveform of the voltage Vref at the non-inverting input terminal of the comparator CM2, a waveform of the voltage Vch at the inverting input terminal of the comparator CM2, and the on/off state of the discharge switch element SW2. Since the smoothing capacitor C is actually discharged every time the discharge switch element SW2 is turned on, Vc decreases and thus V_{refH} and V_{refL}, gradually decrease together with Vc as described above. This is not described in terms of FIG. 10, but is described below with reference to FIGS. 11 to 13.

FIGS. 11 to 13 are diagrams illustrating principles in which the duty ratio increases with a decrease in the voltage Vc at both ends of the smoothing capacitor C. In FIGS. 11 to 13, Z1 represents a curve of the voltage of the capacitor C4 increasing from 0 V to 15 V (charging operation), and Z2 represents a curve of the voltage of the capacitor C4 decreasing from 15V to 0V (discharging operation).

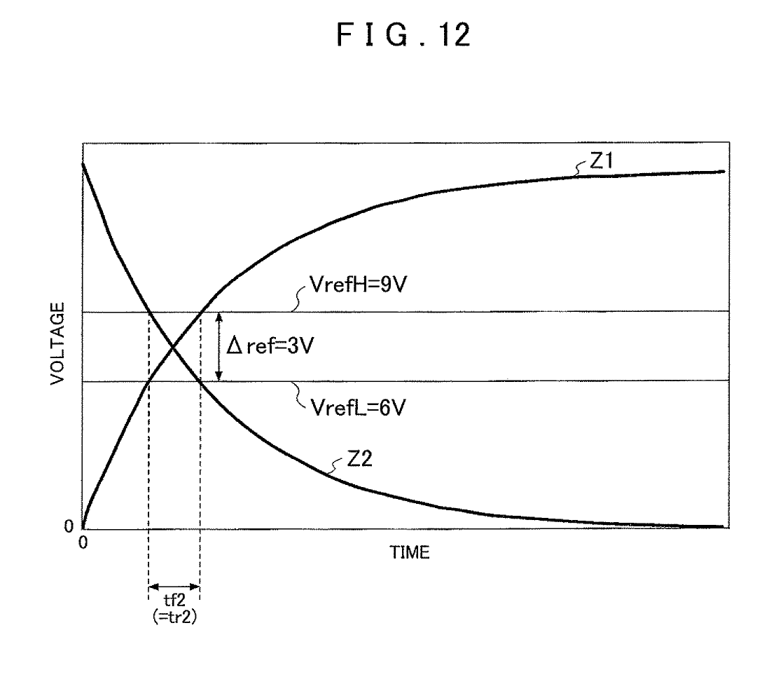

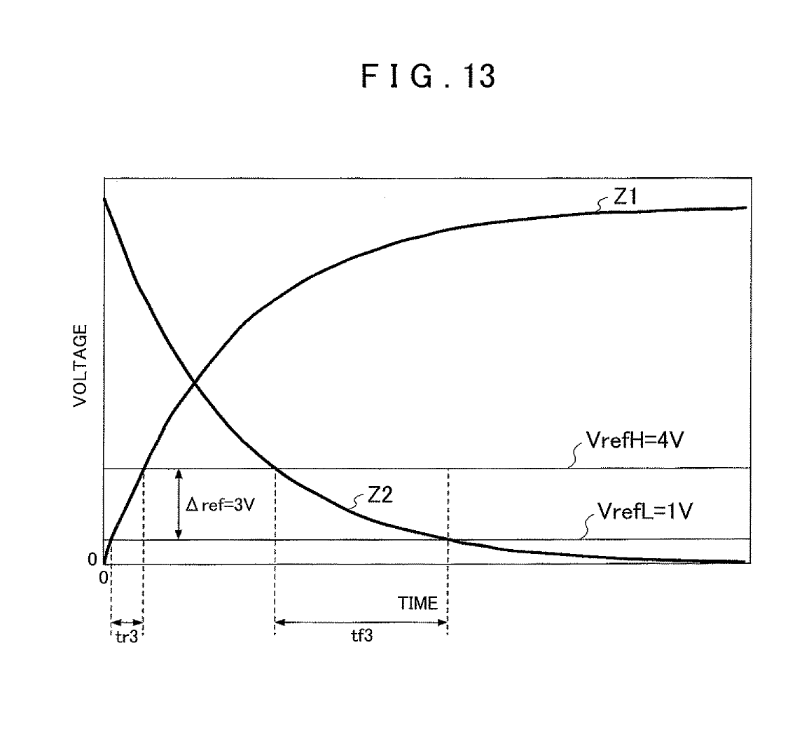

As shown in, e.g., FIG. 11, V_{refH} and V_{refL} are 14 V and 11 V, respectively, immediately after discharge is started. In this case, the time it takes for the voltage Vch at the inverting input terminal of the comparator CM2 to increase from V_{refL} to V_{refH} is tr1, and the time it takes for the voltage Vch at the inverting input terminal of comparator CM2 to decrease from V_{refH} to V_{refL} is tf1. At this time, the duty ratio is tf1/(tf1+tr1). As can be seen from FIG. 11, tf1<tr1. Accordingly, the duty ratio is lower than 0.5. As the discharge progresses, V_{refH} and V_{refL} change to 9V and 6V, respectively, as shown in, e.g., FIG. 12. In this case, the time it takes for the voltage Vch at the inverting input terminal of the comparator CM2 to increase from V_{refL} to V_{refH} is tr2, and the time it takes for the voltage Vch at the inverting input terminal of the comparator CM2 to decrease from V_{refH} to V_{refL} is tf2. At this time, the duty ratio is tf2/(tf2+tr2). In the example shown in FIG. 12, tf2=tr2 and the duty ratio is 0.5. As the discharge further progresses, V_{refH} and V_{refL} change to 4V and 1V, respectively, as shown in, e.g., FIG. 13. In this case, the time it takes for the voltage Vch at the inverting input terminal of the comparator CM2 to increase from V_{refL} to V_{refH} is tr3, and the time it takes for the voltage Vch at the inverting input terminal of the comparator CM2 to decrease from V_{refH} to V_{refL} is tf3. At this time, the duty ratio is tf3/(tf3+tr3). As can be seen from FIG. 13, tf3>tr3. Accordingly, the duty ratio is higher than 0.5. Thus, it can be seen that the duty ratio increases with a decrease in the voltage Vc at both ends of the smoothing capacitor C.

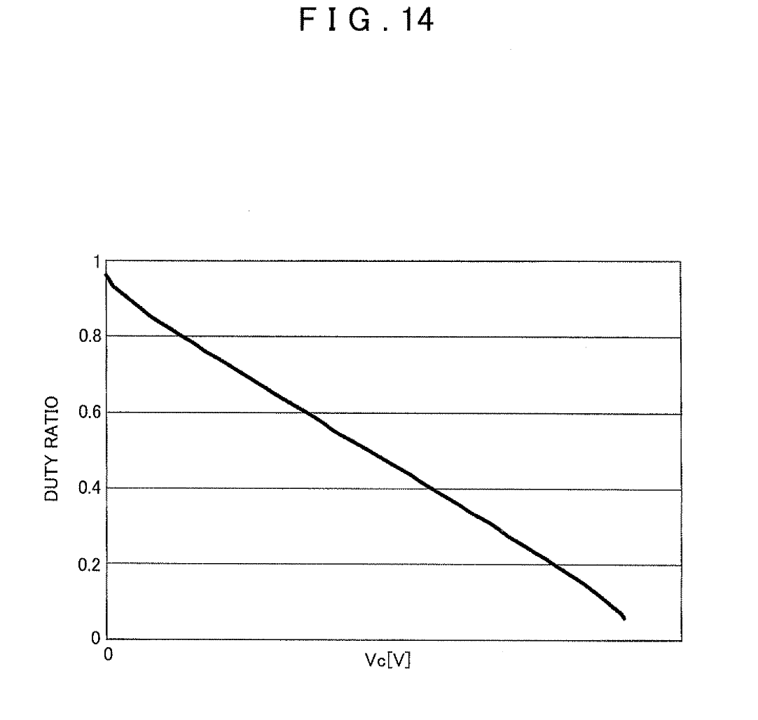

FIG. 14 shows the relation between the voltage Vc at both ends of the smoothing capacitor C and the duty ratio when the variable duty generation circuit 64B is operated. As shown in FIG. 14, linearity is ensured in a substantially entire region, although there are somewhat nonlinear portions where the duty ratio is near 0 and 1. This shows that the variable duty generation circuit 64B can generate an on/off signal having a duty ratio that increases substantially in proportion to a decrease from the voltage Vi at both ends of the smoothing capacitor C at the start of fast discharge (Vi−Vc).

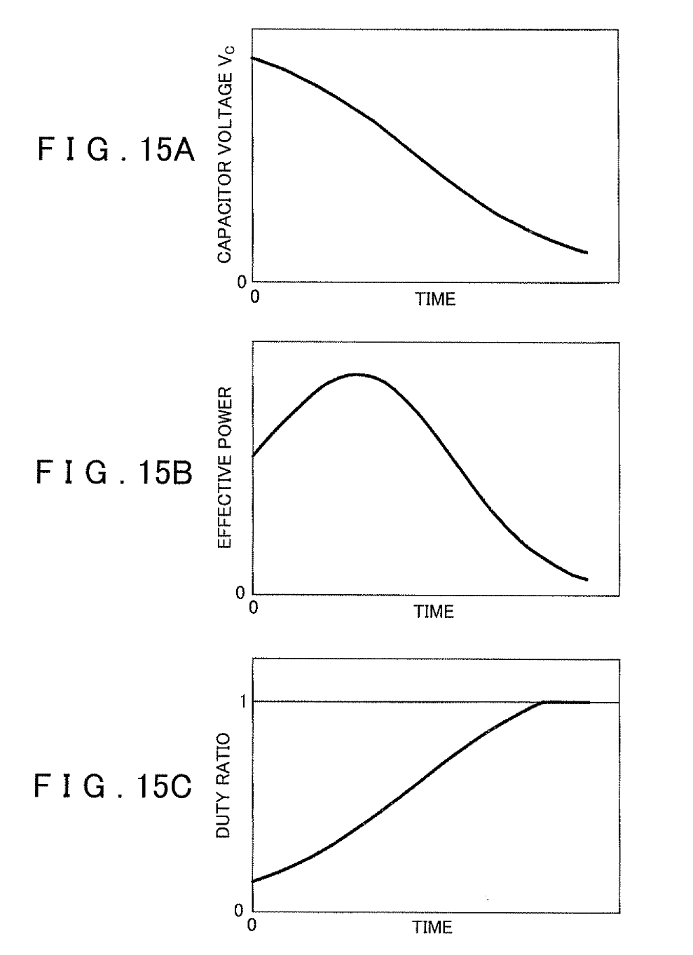

FIGS. 15A to 15C show waveform charts illustrating the discharge operation that is implemented by the fast discharge control device 60B shown in FIG. 9. FIG. 15A shows a waveform of the voltage Vc at both ends of the smoothing capacitor C in time series, FIG. 15B shows in the same time series a waveform of the resistor effective power in the fast discharge resistor R1, and FIG. 15C shows in the same time series a waveform of the duty ratio of the discharge switch element SW2.

As shown in FIG. 15C, in this example, the duty ratio is set to increase from a small value (e.g., around 0.2) to 1 so as to increase substantially in proportion to a decrease from the voltage Vi at both ends of the smoothing capacitor C at the start of fast discharge (Vi−Vc). As shown in FIG. 15B, the resistor effective power (power peak value×duty ratio) does not become constant from the beginning of fast discharge, but its peak value is sufficiently small. As shown in FIG. 15A, the voltage Vc at both ends of the smoothing capacitor C gradually decreases by the discharge via the fast discharge resistor R1, and is reduced to a predetermined target voltage within a predetermined time from the start of fast discharge.

Although the preferred embodiments are described in detail above, the present invention is not limited to the above embodiments, and various modifications and replacements can be made to the above embodiments without departing from the scope of the present invention.

For example, in the above embodiments, the variable duty generation circuit 64A generates a variable duty by using a microcomputer (CPU 641), and the variable duty generation circuit 6413 generates a variable duty by an analog circuit without using a microcomputer. However, a variable duty can be generated by various methods. For example, a similar variable duty may be generated by using a triangular wave. The function of the abnormality detection circuit 66 may be implemented by using a microcomputer.

In the above embodiments, as a preferred embodiment, the power supply circuit 64 generates power source by using the voltage Vc at both ends of the smoothing capacitor C. However, the power supply circuit 64 may generate necessary power source from a low voltage battery.

What is claimed is:

1. An electric vehicle inverter device, comprising: an inverter and a smoothing capacitor which are connected in parallel with a high voltage power supply; a fast discharge resistor and a discharge switch element which are connected in parallel with the smoothing capacitor; and a control device that controls the discharge switch element, wherein
the control device duty controls switching of the discharge switch element so that a duty ratio increases with a decrease in a voltage at both ends of the smoothing capacitor, in response to a fast discharge command.

2. The electric vehicle inverter device according to claim 1, wherein
the duty ratio is set so as to increase as time passes after start of fast discharge.

3. The electric vehicle inverter device according to claim 2, wherein
the duty ratio is set so that a voltage pulse less than a rated pulse voltage of the fast discharge resistor is applied to the fast discharge resistor.

4. The electric vehicle inverter device according to claim 3, wherein
the duty ratio is set so as to increase in inverse proportion to a square of the voltage at the both ends of the smoothing capacitor.

5. The electric vehicle inverter device according to claim 3, wherein
the duty ratio is set so as to increase substantially in proportion to a decrease in the voltage at the both ends of the smoothing capacitor after the start of the fast discharge.

6. The electric vehicle inverter device according to claim 5, wherein
the control device includes a variable duty generation circuit,
the variable duty generation circuit includes a comparator that produces an output that turns on/off the discharge switch element, and
the comparator is configured to compare a reference voltage value that is generated from the voltage at the both ends of the smoothing capacitor and that changes by a constant amount according to switching between a high level and a low level of the output of the comparator, with a capacitor voltage that increases and decreases at a predetermined time constant according to the switching between the high level and the low level of the output of the comparator.

7. The electric vehicle inverter device according to claim 4, wherein
the control device includes a power supply circuit that generates a power supply voltage from the voltage at the both ends of the smoothing capacitor.

8. The electric vehicle inverter device according to claim 7, wherein
the control device includes an abnormality detection circuit that forcibly turns off the discharge switch element based on a manner in which the voltage at the both ends of the smoothing capacitor changes after the start of the fast discharge, or based on lapse of time after the start of the fast discharge.

9. The electric vehicle inverter device according to claim 1, wherein
the duty ratio is set so that a voltage pulse less than a rated pulse voltage of the fast discharge resistor is applied to the fast discharge resistor.

10. The electric vehicle inverter device according to claim 1, wherein
the duty ratio is set so as to increase in inverse proportion to a square of the voltage at the both ends of the smoothing capacitor.

11. The electric vehicle inverter device according to claim 1, wherein
the duty ratio is set so as to increase substantially in proportion to a decrease in the voltage at the both ends of the smoothing capacitor after the start of the fast discharge.

12. The electric vehicle inverter device according to claim 1, wherein
the control device includes a power supply circuit that generates a power supply voltage from the voltage at the both ends of the smoothing capacitor.

13. The electric vehicle inverter device according to claim 1, wherein
the control device includes an abnormality detection circuit that forcibly turns off the discharge switch element based on a manner in which the voltage at the both ends of the smoothing capacitor changes after the start of the fast discharge, or based on lapse of time after the start of the fast discharge.

14. The electric vehicle inverter device according to claim 2, wherein
the duty ratio is set so as to increase in inverse proportion to a square of the voltage at the both ends of the smoothing capacitor.

15. The electric vehicle inverter device according to claim 2, wherein
the duty ratio is set so as to increase substantially in proportion to a decrease in the voltage at the both ends of the smoothing capacitor after the start of the fast discharge.

16. The electric vehicle inverter device according to claim 2, wherein
the control device includes a power supply circuit that generates a power supply voltage from the voltage at the both ends of the smoothing capacitor.

17. The electric vehicle inverter device according to claim 2, wherein
the control device includes an abnormality detection circuit that forcibly turns off the discharge switch element based on a manner in which the voltage at the both ends of the smoothing capacitor changes after the start of the fast discharge, or based on lapse of time after the start of the fast discharge.

18. The electric vehicle inverter device according to claim 9, wherein
the duty ratio is set so as to increase in inverse proportion to a square of the voltage at the both ends of the smoothing capacitor.

19. The electric vehicle inverter device according to claim 9, wherein
the duty ratio is set so as to increase substantially in proportion to a decrease in the voltage at the both ends of the smoothing capacitor after the start of the fast discharge.

20. The electric vehicle inverter device according to claim 9, wherein
the control device includes a power supply circuit that generates a power supply voltage from the voltage at the both ends of the smoothing capacitor.
